(19) United States
(12) Patent Application Publication
(10) Pub. No.: US 2013/0173056 A1
(43) Pub. Date: Jul. 4, 2013

(54) Short-Range Sonar

(71) Applicants: Stephen J. Balas, Midlothian, VA (US); Ralph C. McCann, III, Williamsburg, VA (US)

(72) Inventors: Stephen J. Balas, Midlothian, VA (US); Ralph C. McCann, III, Williamsburg, VA (US)

(73) Assignee: INTELLIBOT ROBOTICS LLC, Richmond, VA (US)

(21) Appl. No.: 13/341,321

(22) Filed: Dec. 30, 2011

(51) Int. Cl. B25J 13/08; G01S 15/04; G01S 15/02

(52) U.S. Cl. 700/258; 367/87; 367/93; 901/1

(57) ABSTRACT

A short-range sonar assembly. The assembly includes a local controller operably connected to a processing device and configured to receive instructions from the processing device, a first transducer operably connected to the local controller, a second transducer operably connected to the local controller; and a flared bell configured to house the local controller, first transducer, and second transducer. The flared bell includes a first enclosure configured to receive and house the first transducer and a second enclosure configured to receive and house the second transducer. The first transducer is configured to transmit one or more pulses and the second transducer is configured to receive echoed pulses.

### BACKGROUND

The present disclosure relates to a short-range sonar system. More specifically, the present disclosure relates to a small scale sonar system configured to operate at short-ranges.

Existing sonar systems, such as ultrasonic sonar systems, are useful in determining a distance between the sonar system and a solid object. However, due to the physical characteristics of typical sonar systems, they do not provide as narrow a focus as may be desired for short-range operations. As such, due to these technical limitations, existing sonar systems typically cannot detect an object closer than about 200 millimeters.

Many devices utilize short-range sonar systems. For example, robots such as automatic vacuum devices use a combination of short-range sonar and long-range sonar. Using this combination of short and long-range sonars, a robotic device can detect objects between 200 millimeters and 2.5 meters away. However, for use in cramped environments such as a home cluttered with furniture and other objects, this range may not be adequate to provide the robotic device with an appropriately functional sonar system for its surroundings.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this document is to be construed as an admission that the embodiments described in this document are not entitled to antedate such disclosure by virtue of prior invention. As used in this document, the term “comprising” means “including, but not limited to.”

In one general respect, the embodiments disclose a short-range sonar assembly. The assembly includes a local controller operably connected to a processing device and configured to receive instructions from the processing device, a first transducer operably connected to the local controller, a second transducer operably connected to the local controller; and a flared bell configured to house the local controller, first transducer, and second transducer. The flared bell includes a first enclosure configured to receive and house the first transducer and a second enclosure configured to receive and house the second transducer.

In another general respect, the embodiments disclose a robotic device. The robotic device includes a processing device, a short-range sonar assembly, and a transportation mechanism operably connected to the processing device and configured to move the robotic device in various directions in response to instructions from the processing device. The short range sonar assembly includes a local controller operably connected to the processing device and configured to receive instructions from the processing device, a first transducer operably connected to the local controller, a second transducer operably connected to the local controller, and a sonar horn configured to house the local controller, first transducer, and second transducer. The sonar horn includes a first enclosure configured to receive and house the first transducer, a second enclosure configured to receive and house the second transducer, and a third enclosure configured to receive and house the local controller.

In another general respect, the embodiments disclose a method of detecting objects with a short-range sonar. The method includes transmitting, via a first transducer, one or more pulses, wherein the first transducer is mounted in a first enclosure such that the one or more pulses are transmitted in a narrow beam; receiving, via a second transducer, the one or more pulses as echo pulses having reflected off an object, wherein the second transducer is mounted in a second enclosure such that the echo pulses are received as a narrow beam; detecting, at a local controller operably connected to the second transducer, the echo pulses; and determining, by a processing device operably connected to the local controller, a position of the object.

### BRIEF DESCRIPTION OF THE DRAWINGS

FIG. 1 illustrates a block diagram showing a robotic device according to an embodiment.

FIG. 2 illustrates a horn and kickplate assembly for a short-range sonar system.

FIG. 3 illustrates an exploded view of the horn and kickplate assembly of FIG. 1.

FIG. 4 illustrates a circuit diagram for a short-range sonar assembly according to an embodiment.

FIG. 5 illustrates a flow diagram for a method of using the short-range sonar assembly according to an embodiment.

### DETAILED DESCRIPTION

As used herein, a “robot” or “robotic device” is a stand-alone system, for example, that is mobile and performs both physical and computational activities. The physical activities may be performed using a wide variety of movable parts including various tools, for example. The computational activities may be performed utilizing a suitable processor and computer readable memory devices, e.g., a data memory storage device, for example. The computational activities may include processing information input from various sensors or other inputs of the robotic device to perform commanded functions; processing the input information, as well as other data in the memory stores of the robotic device, to generate a variety of desired information; or outputting information that has been acquired or produced by the robotic device to a desired destination, for example.

“Short-range” sonar refers to a range from 0 mm to about 900 mm from a sonar system. For example, a short-rage sonar system according to an embodiment of the present disclosure may be configured to detect objects between 100 mm and 900 mm away from the sonar system. In an alternate embodiment, a short-range sonar system may be configured to detect objects between 50 mm and 900 mm away from the sonar system.

“Long-range” sonar refers to a range 1000 mm to about 9500 mm from the sonar system. For example, a long-rage sonar system according to an embodiment of the present disclosure may be configured to detect objects between 1000 mm and 9500 mm away from the sonar system.

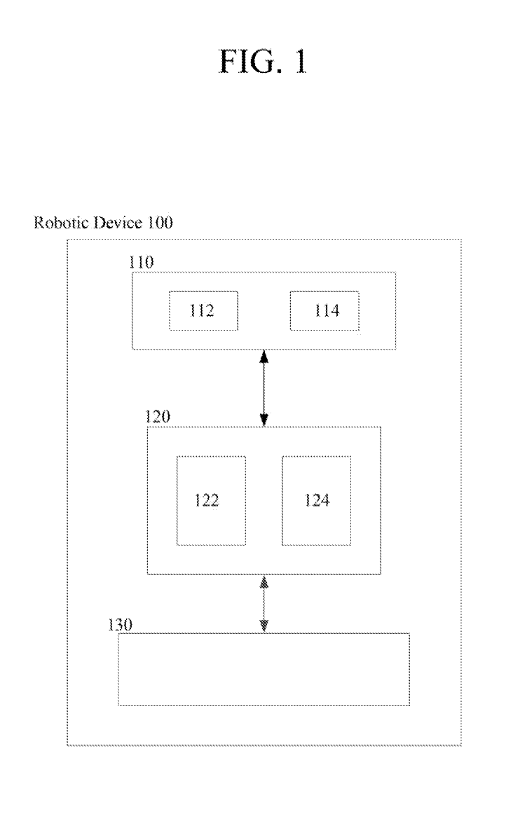

FIG. 1 illustrates a block diagram showing a mobile robotic device 100 in accordance with one embodiment of the present disclosure. As shown in FIG. 1, the robotic device 100 may include a sensor portion 110, a control portion 120 operably connected to the sensor portion, and a transport portion 130 operably connected to the control portion. It should be noted that the elements as shown in FIG. 1 are shown by way of example only. Additional information related to specific robotic devices is shown in U.S. Pat. No. 6,667,592, the content of which is hereby incorporated by reference in its entirety.

The sensor portion may include various components such as a short-range sonar assembly 112, a long-range sonar assembly 114, and other various sensor mechanisms such as a laser-based sensor, a global positioning system (GPS) device, a microwave sensor, and other similar sensors. The control portion 120 may include a processor 122 and a tangible computer readable medium 124 such as a hard drive, an optical drive, a flash drive, a read-only memory or a random access memory. The transport portion 130 may include a mechanical system of wheels or an electromechanical system, for example, for moving the robotic device from one place to another.

The components of the robotic device 100 as described may be configured to perform a wide variety of operations. The processor 122 may monitor and controls various operations of the robotic device 100. The computer readable medium 124 may be configured to store a wide variety of instructions and/or data used by the processor 124 as well as the other components of the robotic device 100.

The block diagram of FIG. 1 illustrates various operating components of the robotic device 100. It should be appreciated that the operating components of the robotic device 100, or select operating components of the robotic device 100, may be encased or enclosed in a suitable body or body portion. Alternatively, it should be appreciated that the operating components of the robotic device 100 may simply be suitably disposed on a support framework or structure.

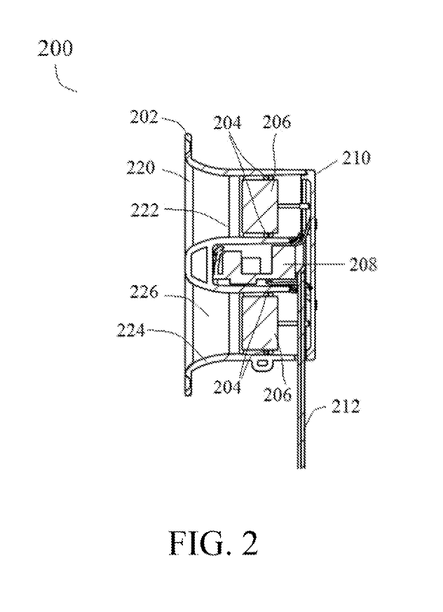

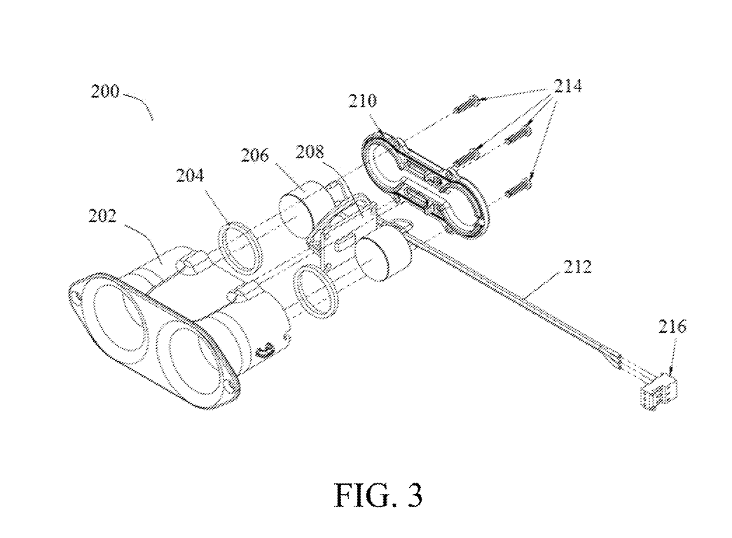

FIG. 2 illustrates an exemplary short-range sonar assembly 200 for use in a robotic device such as robotic device 100 as shown in FIG. 1. The assembly 200 may include a molded or otherwise formed sonar horn 202 configured to enclose various other components of the assembly as well as direct any sonar signals emitted by the assembly and receive any echo signals resulting from the emitted sonar signals. Two or more sonar sensors 206, including at least one transmit transducer and one receive transducer, may be placed within separate enclosures or in separate positions in the sonar horn and held in position by O-rings 204, or another similar positioning device such as a grommet. In an exemplary embodiment, the O-rings 204 are made of rubber or another similarly deformable material such that a tight fit is formed between the sensors 206 and the horn 202, thus providing a watertight or water-resistant assembly 200. The horn 202 may further house a printed circuit board (PCB) 208 in an enclosure sized to receive and protect the PCB. The rear halves of the sensors 206 and the PCB 208 may be encased in a potting compound to hold and waterproof the components. The PCB 208 may be configured to control operation of both the sensors 206. A wire harness 212 may be operably connected to the PCB 208 and a processing device such as processor 122 as shown in FIG. 1. The various components may be held within the horn 202 by a backplate 210 removably affixed to the horn via a plurality of fasteners 214 (as seen in FIG. 3). Thus, the horn 202 is designed to enclose both sonar sensors 206 and the PCB 208, resulting in self-contained sonar assembly.

The design of the horn 202 may be based upon the intended function of the assembly 200, i.e., to provide a short-range sonar assembly. The horn may have various specific design characteristics such as a lip or outer diameter 220, a rim or inner diameter 222, and a curved sidewall 224 that together form or define an opening or bell. The shape and design of the horn 202 may concentrate signals emitted from the sensors 206 be directed in a narrow beam such that any received echo signals are received in a similarly concentrated beam. For example, the sensors 206 may be placed within the horn 202 such that pulses emitted from the sensors are confined and concentrated by the bell shape of the horn, resulting in a narrow beam of emitted pulses. This narrow beam, and a resulting narrowly focused echoes or returned signals, allows the sensor assembly 200 to be configured to operate as a short-range sonar assembly. The horn 202 may be designed to minimize impedance mismatch between the sensors' face and the air of the environment in which the robotic device is operating. Specifically, the lip or outer diameter 220 may contribute to minimizing any impedance mismatch.

In an exemplary embodiment, the inner diameter 222 may be slightly larger than an outer diameter of the sensors 206, e.g., the sensor's outer diameter may be 18 mm and the horn's inner diameter may be 20.6 mm. The horn 202 may be further designed such that the curve 224 defines a slowly expanding cavity 226 between the sensors 206 and the outside of the horn. The outer diameter 220 may be approximately equal to the inner diameter 222 plus the distance of curve 224. However, it should be noted that the specific design of horn 202 as shown in FIG. 2 is by way of example only and may be modified based upon desired sonar distances, scale of the robotic device the assembly 200 is being integrated into, and other various factors.

In an exemplary embodiment, each of sensors 206 may be a short-range sonar transducer. One of the transducers may be configured to transmit sonar signals while a second transducer is configured to receive any echoes or returned signals. In a typical short-range sonar, a single transducer is used for both transmit and receive. However, this arrangement requires a period of time to switch the transducer between transmit and receive. The multiple transducer arrangement as shown in FIG. 2 does not require this switching period. Rather, each of the transducers 206 may be operating simultaneously. Additionally, in a preferred embodiment, the sensors 206 are closed-face sensors, thereby further protecting the sensor from any water or debris.

An exemplary sensor 206 may be a tunable ultrasonic piezoelectric transducer. The transducer may be configured to operate at approximately 40 KHz, +/−1.0 KHz, and having a 1.5 KHz bandwidth. The transducer may have a transmitting sound pressure level of approximately 115 dB at 40 KHz, and a receiving sensitivity of approximately −70 dB at 40 KHz. The transducer may be configured to output beam or set of pulses having a transmission angle approximately 30° wide, which is further narrowed by the geometry of the horn 202 as discussed above. Depending on the application of the transducer, the transducer may be tuned to produce a specific band of transmitted signals, and similarly tuned to receive a specific band of echoed signals.

FIG. 3 shows an exploded view of the short-range sonar assembly of FIG. 2, illustrating how the various components are fitted together. In an exemplary embodiment, the O-rings 204 are placed into the horn 202. The sensors 206 and the PCB 208 are placed into the horn such that the sensors contact the O-rings 204, thereby resulting in a watertight seal between the O-rings and the sensors. The wire harness 212 may be operably connected to the PCB 208 prior to assembly, e.g., via solder connections. Alternatively, the wire harness 212 may be removably connected to the PCB 208 during assembly, e.g., via a modular connector. The wire harness 212 may also terminate in a connector 216 for operably connecting to another component in the robotic device 100 such as the processor 120.

The various components may be physically held within the assembly 200 by a backplate 210 removably attached to the horn 202 via a plurality of fasteners 214. The fasteners 214 may be screws, bolts, clips, or other similar removable fastening devices.

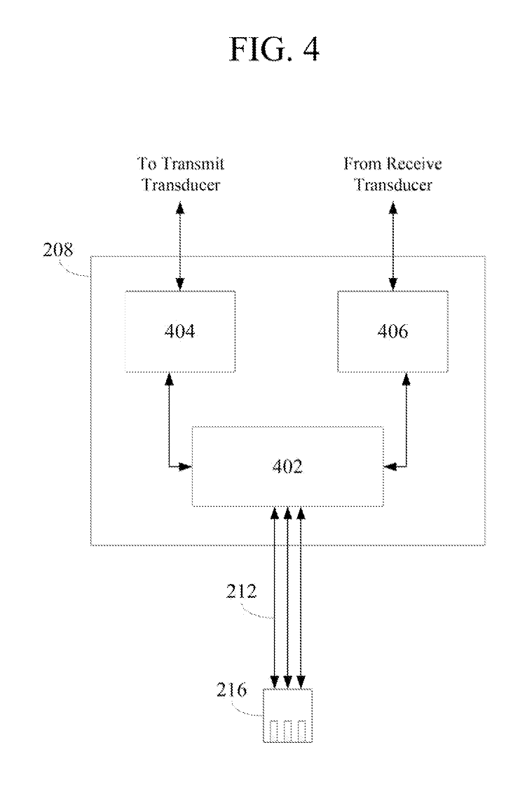

FIG. 4 illustrates an exemplary circuit diagram for PCB 208. The PCB 208 may include a logic controller 402 operably connected to a processing device such as processor 122 via the wire harness 212 and the connector 216. The logic controller 402 may be configured to receive instructions from the processing device related to specific operation of the sensors 206. For example, the processing device may transmit an instruction to the logic controller 402 to begin sonar operation. The logic controller 402 may be operably connected to sensor drivers 404 and 406. It should be noted that two sensor drivers 404, 406 are shown by way of example only. In an alternate embodiment, a single sensor driver may be used.

Sensor driver 404 may be operably connected to the transmit transducer and configured to receive an instruction from the logic controller 402 to begin transmitting pulse signals. Upon receipt of the instruction, the sensor driver 404 may drive the transmit transducer to begin transmitting the pulses accordingly. Similarly, the sensor driver 406 may be operably connected to the receive transducer and configured to receive any echoes detected by the receive transducer. Any received pulses may be transferred from the sensor driver 406 to the logic controller 402 for further processing and transmission to the processing device.

It should be noted the inclusion and arrangement of the components on PCB 208 as shown in FIG. 4 is shown by way of example only and may be adjusted based upon the functions of the individual components and the implementation of the PCB. For example, the individual sensors may include driver logic and be mounted directly on the PCB 208 and operably connected to the logic controller 402.

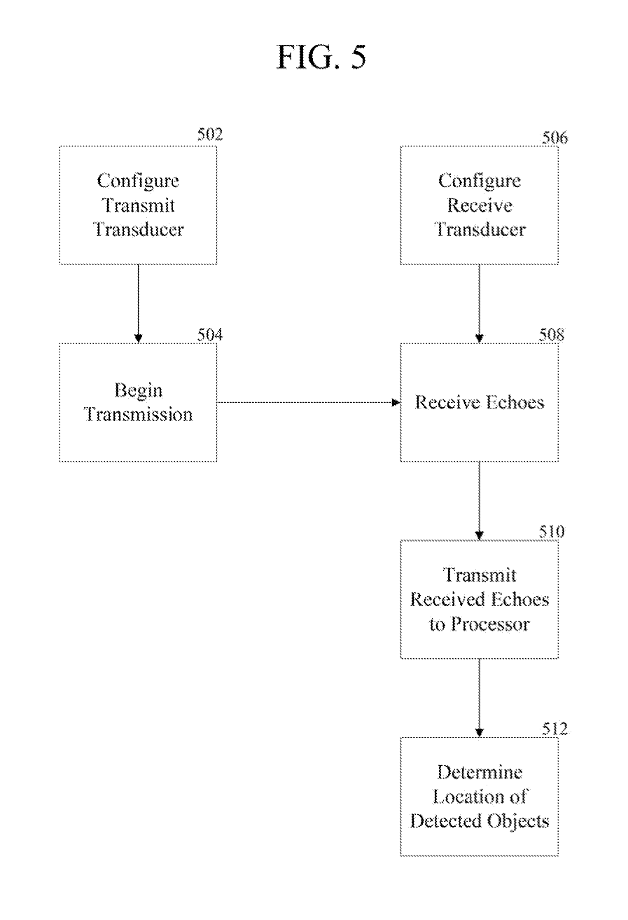

FIG. 5 illustrates an exemplary flow chart for using a short-range sonar assembly integrated in a robotic device according to an exemplary embodiment. The transmit transducer may be configured 502 via instructions sent from the processing device to a local controller (e.g., logic controller 402 as shown in FIG. 4), and then sent to either the transmit transducer or to a driver operably connected to the transmit transducer. The configured 502 transmit transducer may then begin transmitting 504 pulses as instructed by the processing device.

The receive transducer may be configured 506 via instructions sent from the processing device to the local controller. The receive transducer may receive 508 echoes from one or more objects in close proximity to the receive transducer. The received echoes are detected by the local controller and transmitted 510 to the processing device. The processing device may process this information to determine 512 the location of the object(s) in close proximity. The processing device may send instructions to various other components such as a motor or other drive mechanism to steer the robotic device away from or around the object(s). A software algorithm used by the processing device to determine the location of the object(s) may be able to accept or reject echoes based upon a width (in time) of the returned echoes. This software algorithm may be useful in determining whether an object is on the edge of the beam angle, or more directly in front of the sensor.

The above discussed short-range sonar may be integrated into various products and applications where detecting an object at a close distance is desirable. For example, as discussed above, automatic vacuuming devices may incorporate a short-range sonar assembly as described herein to better detect objects positioned about the vacuum device. Additionally, auto manufacturers may incorporate a similar short-range sonar assembly into various positions on a vehicle such as the front and rear bumper to detect when the vehicle is approaching another car, e.g., during parking.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A short-range sonar assembly comprising:
a local controller operably connected to a processing device and configured to receive instructions from the processing device;
a first transducer operably connected to the local controller;
a second transducer operably connected to the local controller; and
a flared bell configured to house the local controller, first transducer, and second transducer, the flared bell comprising:
a first enclosure configured to receive and house the first transducer, and
a second enclosure configured to receive and house the second transducer.

2. The assembly of claim 1, wherein the flared bell further comprises a third enclosure configured to receive and house the local controller.

3. The assembly of claim 1, wherein the first transducer is configured to transmit one or more pulses and the second transducer is configured to receive echoed pulses.

4. The assembly of claim 3, wherein the first enclosure is shaped such that the one or more transmitted pulses are transmitted in a narrow beam.

5. The assembly of claim 4, wherein the second enclosure is shaped such that the echoed pulses are received in a narrow beam.

6. The assembly of claim 1, wherein the local controller is mounted on a printed circuit board positioned within the third enclosure.

7. The assembly of claim 1, wherein the first and second transducers comprise ultrasonic piezoelectric transducers.

8. The assembly of claim 1, wherein the assembly further comprises a backplate removably affixed to the sonar horn and positioned to hold the first transducer, second transducer and the local controller within the sonar horn.

9. A robotic device comprising:
a processing device;
a short-range sonar assembly comprising:
a local controller operably connected to the processing device and configured to receive instructions from the processing device,
a first transducer operably connected to the local controller,
a second transducer operably connected to the local controller, and
a sonar horn configured to house the local controller, first transducer, and second transducer, the sonar horn comprising:
a first enclosure configured to receive and house the first transducer,
a second enclosure configured to receive and house the second transducer, and
a third enclosure configured to receive and house the local controller; and
a transportation mechanism operably connected to the processing device and configured to move the robotic device in various directions in response to instructions from the processing device.

10. The device of claim 9, wherein the first transducer is configured to transmit one or more pulses and the second transducer is configured to receive echoed pulses.

11. The device of claim 10, wherein the first enclosure is shaped such that the one or more transmitted pulses are transmitted in a narrow beam.

12. The device of claim 11, wherein the second enclosure is shaped such that the echoed pulses are received in a narrow beam.

13. The device of claim 9, wherein the local controller is mounted on a printed circuit board positioned within the third enclosure.

14. The device of claim 9, wherein the first and second transducers comprise ultrasonic piezoelectric transducers.

15. The device of claim 9, wherein the assembly further comprises a backplate removably affixed to the sonar horn and positioned to hold the first transducer, second transducer and the local controller within the sonar horn.

16. A method of detecting objects with a short-range sonar, the method comprising:
transmitting, via a first transducer, one or more pulses, wherein the first transducer is mounted in a first enclosure such that the one or more pulses are transmitted in a narrow beam;
receiving, via a second transducer, the one or more pulses as echo pulses having reflected off an object, wherein the second transducer is mounted in a second enclosure such that the echo pulses are received as a narrow beam;
detecting, at a local controller operably connected to the second transducer, the echo pulses; and
determining, by a processing device operably connected to the local controller, a position of the object.

17. The method of claim 16, wherein the first transducer is configured to transmit simultaneously while the second transducer is receiving.

18. The method of claim 16, wherein the first and second transducers comprise ultrasonic piezoelectric transducers.
